(19) United States
(12) Patent Application Publication
(10) Pub. No.: US 2025/0080377 A1
(43) Pub. Date: Mar. 6, 2025

(54) Real-time On-Chip traffic monitoring in an automotive network device

(71) Applicant: Marvell Asia Pte Ltd, Singapore (SG)

(72) Inventors: Yuyi Tang, Karlsruhe (DE); Felix Ning, Karlsruhe (DE); Xiongzhi Ning, Karlsruhe (DE)

(21) Appl. No.: 18/817,302

(22) Filed: Aug. 28, 2024

Related U.S. Application Data
(60) Provisional application No. 63/535,159, filed on Aug. 29, 2023.
(60) Provisional application No. 63/656,375, filed on Jun. 5, 2024.

(51) Int. Cl. H04L 12/40; H04L 43/0876

(52) U.S. Cl. CPC H04L 12/4013; H04L 12/40006; H04L 43/0876; H04L 2012/40273

(57) ABSTRACT

A network device, for use in an automotive network, includes a semiconductor die, network-device circuitry and an on-chip traffic monitor. The network-device circuitry is disposed on the die and is configured to transfer traffic of the automotive network. The on-chip traffic monitor is disposed on the die and is configured to monitor the traffic traversing the network-device circuitry from one or more sources in the automotive network to one or more destinations in the automotive network, and to detect a performance degradation in the network-device circuitry by analyzing the monitored traffic.

### CROSS-REFERENCE TO RELATED APPLICATIONS

This application claims the benefit of U.S. Provisional Patent Application 63/535,159, filed Aug. 29, 2023, and U.S. Provisional Patent Application 63/656,375, filed Jun. 5, 2024, whose disclosures are incorporated herein by reference.

### FIELD OF THE DISCLOSURE

The present disclosure relates generally to network communication, and particularly to methods and systems for traffic monitoring in network devices.

### BACKGROUND

Communication networks are sometimes used in mission-critical applications and are therefore required to meet high standards of reliability. One typical example is an automotive network used for communication between sensors, Electronic Control Units (ECUs) and other units in a vehicle. Since network reliability in a vehicle is directly related to driver safety, components of automotive networks are required to be highly reliable. For example, network devices may be required to meet a specified Failure Tolerant Time Interval (FTTI)—A maximum time permitted from occurrence of a fault until transition to a safe state.

The description above is presented as a general overview of related art in this field and should not be construed as an admission that any of the information it contains constitutes prior art against the present patent application.

### SUMMARY

An embodiment that is described herein provides a network device for use in an automotive network. The network device includes a semiconductor die, network-device circuitry and an on-chip traffic monitor. The network-device circuitry is disposed on the die and is configured to transfer traffic of the automotive network. The on-chip traffic monitor is disposed on the die and is configured to monitor the traffic traversing the network-device circuitry from one or more sources in the automotive network to one or more destinations in the automotive network, and to detect a performance degradation in the network-device circuitry by analyzing the monitored traffic.

In some embodiments, the on-chip traffic monitor is configured to select a traffic flow from within the traffic, and to detect the performance degradation in the selected traffic flow.

In some embodiments, the network-device circuitry includes (i) multiple port circuits, disposed on the die and configured to transmit and receive packets over the automotive network, (ii) a switch fabric, disposed on the die and configured to forward the packets between the port circuits, and (iii) interconnection circuitry, disposed on the die and configured to connect the switch fabric to a host via a peripheral bus. The on-chip traffic monitor may be coupled to the interconnection circuitry.

In an example embodiment, the on-chip traffic monitor is configured to identify, in the traffic, a traffic flow associated with a given bus function of the peripheral bus, and to detect the performance degradation by analyzing the identified traffic flow separately from one or more other traffic flows.

In another embodiment, the interconnection circuitry includes a plurality of Direct Memory Access (DMA) engines, and the on-chip traffic monitor is configured to identify, in the traffic, a traffic flow associated with a given DMA engine in the plurality, and to detect the performance degradation by analyzing the identified traffic flow separately from one or more other traffic flows.

In yet another embodiment, the on-chip traffic monitor is configured to: identify, in the traffic, a traffic flow associated with one of (i) a virtual circuit, (ii) a port circuit among the port circuits, (iii) Time-Sensitive Network (TSN) traffic, (i) a defined memory region in a memory of the host, and (v) Message-Signaled Interrupt (MSI) traffic; and detect the performance degradation by analyzing the identified traffic flow separately from one or more other traffic flows.

In still another embodiment, the on-chip traffic monitor includes one or more hardware counters, the on-chip traffic monitor being configured to assign a hardware counter among the hardware counters for measuring a traffic throughput of a selected traffic flow within the traffic. In an example embodiment, the on-chip traffic monitor is configured to measure the traffic throughput by counting, using the hardware counter, a traffic volume of the selected traffic flow over a defined measurement period.

In a disclosed embodiment, the on-chip traffic monitor is configured to notify a host in response to detecting the performance degradation. In an embodiment, the on-chip traffic monitor is configured to notify the host of the performance degradation within less than 100 microseconds from occurrence of the performance degradation. In an example embodiment, the on-chip traffic monitor is configured to detect the performance degradation by analyzing one or more of latencies, changes to intra-packet spacing, dropped packets, data corruption and traffic throughput exhibited in the monitored traffic.

There is additionally provided, in accordance with an embodiment that is described herein, a method of traffic monitoring in a network device of an automotive network. The method includes transferring traffic of the automotive network using network-device circuitry disposed on a semiconductor die. The traffic traversing the network-device circuitry, from one or more sources in the automotive network to one or more destinations in the automotive network, is monitored using an on-chip traffic monitor disposed on the semiconductor die. A performance degradation in the network-device circuitry is detected using the on-chip traffic monitor, by analyzing the monitored traffic.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates an automotive communication system comprising an automotive network switch having an on-chip traffic monitor, in accordance with an embodiment that is described herein; and

FIG. 2 is a flow chart that schematically illustrates a method for on-chip traffic monitoring in the network switch of FIG. 1, in accordance with an embodiment that is described herein.

### DETAILED DESCRIPTION OF EMBODIMENTS

Network devices used in automotive networks are typically required to detect failures, and act upon the detected failures, within very short time periods on the order of 10-100 ms.

Embodiments that are described herein provide improved techniques for detecting performance degradation in network devices. In the present context, the term “performance degradation” includes intermittent faults, permanent failures, and also mild or severe drops in performance metrics of the network device or parts thereof. One demonstrative example of performance degradation is a decrease in the bandwidth of transmitted data via a certain switch port. Such a drop in performance may be problematic in and of itself and it may also be indicative of an imminent failure. Performance degradation can be defined in any suitable way, e.g., as a performance deviation of a defined size from a defined baseline performance.

By detecting performance degradations before they develop to become failures, the disclosed techniques considerably reduce the time needed for failure detection and remediation. The embodiments described herein refer mainly to Ethernet switches in automotive networks, by way of example. The disclosed techniques are, however, generally applicable in other suitable network devices, network types and applications.

In some embodiments, an automotive network device comprises a switch implemented in a System-on-Chip (SoC). The switch communicates with a host over a peripheral bus, e.g., Peripheral Component Interconnect express (PCIe). The SoC comprises network-device circuitry disposed on a semiconductor die. The network-device circuitry may comprise, for example, multiple port circuits (“ports”) for transmitting and receiving packets over the automotive network, a switch fabric that forwards the packets between the port circuits, and interconnection circuitry that connects the switch fabric to the host via the PCIe bus.

In some embodiments, the network device further comprises an on-chip traffic monitor disposed on the die of the switch SoC. The on-chip traffic monitor is configured to monitor traffic traversing the network device-circuitry from a source in the automotive network to a destination in the automotive network, and to detect performance degradation in the network device-circuitry by analyzing the monitored traffic. In various embodiments, the on-chip traffic monitor is disposed at some intermediate location between a data source in the automotive network, such as a camera, range sensor, thermal sensor, audio sensor or other suitable sensor, and a destination in the automotive network such as a vehicle CPU or storage device.

In an example implementation, the on-chip traffic monitor is hardware-implemented and coupled to the interconnection circuitry of the SoC. In monitoring the traffic, the on-chip traffic monitor is able to detect performance degradation in selected traffic flows of interest, with fine granularity. For example, in some embodiments the on-chip traffic monitor is configurable to monitor traffic flows associated with selected Virtual Channels (VCs), PCIe bus functions (physical functions—PFs—and/or virtual functions—VFs), Direct Memory Access (DMA) engines of the SoC, Ethernet ports, memory regions in the memory of the host, interrupt events, as well as Time-Sensitive Network (TSN) traffic flows. Each traffic is flow typically analyzed separately irrespective of other traffic flows.

Such a fine granularity enables the network device to detect even slight degradations in performance with high sensitivity and reliability, and to initiate suitable responsive actions. Moreover, the disclosed techniques analyze the traffic in an intermediate node (a network device) rather than at the end nodes (e.g., the destinations of the traffic). Analyzing traffic in an intermediate node often outperforms analysis at end nodes, since the traffic at the end nodes may be affected by multiple degradations that are hard to distinguish. Identifying a degradation at an intermediate node can be faster, since the detection is closer to the system element in which the degradation occurs. Detection speed may be crucial in an automotive network, as it may have a direct impact on safety.

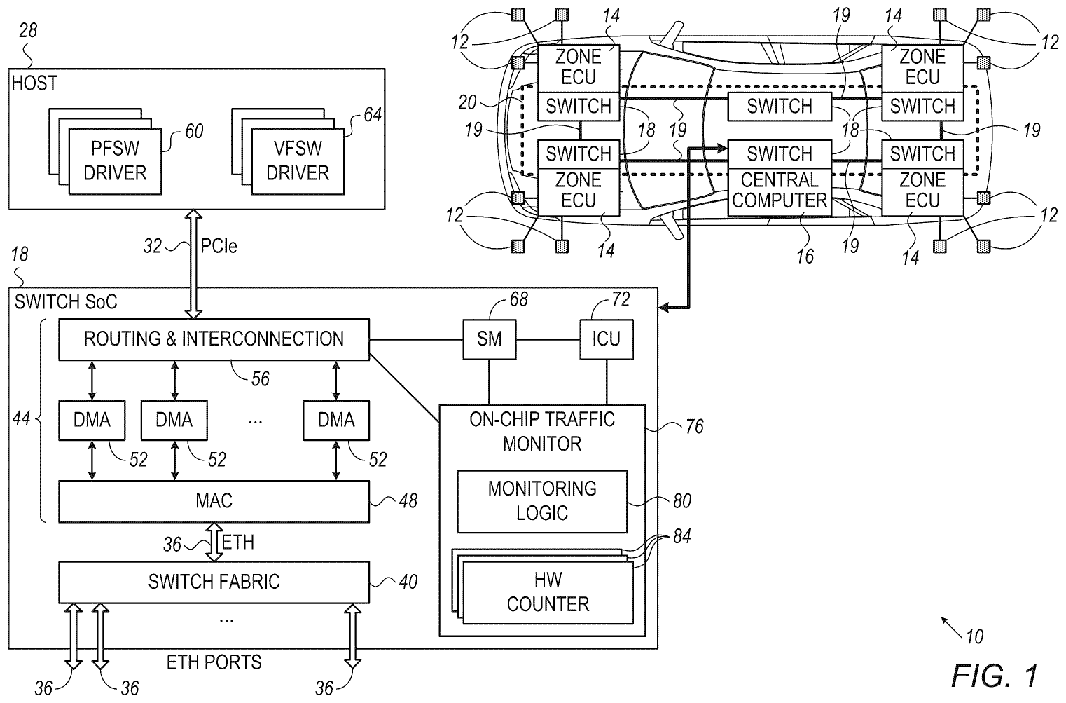

FIG. 1 is a block diagram that schematically illustrates an automotive communication system 10 comprising one or more automotive network switches 18, in accordance with an embodiment that is described herein. In the present example, switches 18 are part of an Ethernet network 20 installed in a vehicle. Generally, however, switches 18 may be used in other suitable network environments. The disclosed techniques can also be implemented in other types of network devices, for example routers.

In an embodiment, the vehicle comprises multiple electronic subsystems 12 of various kinds. Some of subsystems 12 comprise sensors, such as, for example, video cameras, velocity sensors, accelerometers, audio sensors, infra-red sensors, radar sensors, lidar sensors, ultrasonic sensors, rangefinders or other proximity sensors, and/or any other suitable type of sensors. Other subsystems 28 comprise, for example, Advanced Driver Assistance Systems (ADASs) and/or In-Vehicle Infotainment (IVN) systems. Yet other subsystems 28 comprise Electronic Control Units (ECUs) that control vehicle elements such as engine, body, steering and the like. Additionally or alternatively, the vehicle may comprise any other suitable types of electronic subsystems 12.

In some embodiments, the vehicle is divided into multiple zones, and subsystems 12 of each zone are controlled by a respective “Zone ECU” 14. The various zone ECUs 14 communicate with a central computer 16 of the vehicle.

Electronic subsystems 12, ECUs 14 and central computer 16 communicate with one another by sending and receiving communication packets over network 20. In the present example, network 20 operates in accordance with one of the IEEE 802.3 Ethernet standards, e.g., the IEEE 802.3bw-2015, cited above. Network 20 comprises multiple automotive network switches 18, in the present example Ethernet switches. Communication among switches 18, between switches 18 and ECUs 14, and between ECUs 14 and subsystems 12, is carried out over network links 19. Depending on the applicable Ethernet standard, links 19 may comprise any physical medium, e.g., twisted-pair copper links, optical links, waveguides and the like.

The bottom-left of FIG. 1 illustrates the internal structure of an example switch 18, in an embodiment. In some embodiments all switches 18 of network 20 have a similar internal structure. In other embodiments, only a subset of switches 18, possibly only a single switch 18, will have this structure.

In an embodiment, switch 18 is implemented in a System-on-Chip (SoC). The terms “switch”, “SoC” and “switch SoC” are used interchangeably herein. Switch 18 communicates with a host 28 over a Peripheral Component Interconnect express (PCIe) bus 32, in an embodiment. Switch 18 comprises a semiconductor die having electronic circuitry (referred to as “network-device circuitry”) disposed thereon. Generally speaking, the network-device circuitry is configured to perform various packet-processing tasks of switch 18.

In the example of FIG. 1, the network-device circuitry of switch 18 comprises the following:
Multiple Ethernet port circuits 36, also referred to as “ports” for privity.
A switch fabric 40.
Interconnection circuitry 44, comprising (i) a Medium Access Control (MAC) module 48, (ii) a plurality of Direct Memory Access (DMA) engines 52, and (iii) a routing and interconnection matrix 56.

The Ethernet ports 36 seen at the bottom of the figure are configured to communicate over the Ethernet network of the vehicle. Among other tasks, ports 36 are configured to apply physical layer (PHY) processing to the packets in accordance with the applicable IEEE 802.1 standards. One of Ethernet ports 36 is designated for communicating with interconnection circuitry 44. Switch fabric 40 is configured to forward Ethernet packets between ports 36.

Interconnection circuitry 44 is configured to transfer packets, parts of packets and other information between switch fabric 40 and host 28. In an embodiment, MAC module 48 is configured to apply MAC layer processing to the packets in accordance with the applicable IEEE 802.1 standards. DMA engines 52 operate in parallel. To transfer a packet from host 28 to switch fabric 40, one of DMA engines 52 reads the packet data directly from a memory of host 28 (over PCIe bus 32) and sends the read packet data to switch fabric 40. To transfer a packet from switch fabric 40 to host 28, one of DMA engines 52 receives the packet data from switch fabric 40 and writes the packet data directly (over PCIe bus 72) to the memory of host 28. Routing and interconnection matrix 56 routes packets between DMA engines 52 and PCIe bus 32.

In the example of FIG. 1, switch 18 supports Single Root Input-Output Virtualization (SR-IOV). In accordance with SR-IOV, host 28 may run various applications implemented as Virtual Machines (VMs). Applications running on host 28 may comprise, for example, infotainment applications, Advanced Driver Assistance Systems (ADAS) and the like.

In order to serve the various applications, and other entities in host 28 such as a hypervisor, the physical resources of PCIe bus 32 are partitioned into multiple PCIe functions (or, more generally, into multiple bus functions). The functions may comprise one or more Physical Functions (PFs) and/or one or more Virtual Functions (VFs). Host 28 runs one or more PF software (PFSW) drivers 60 and/or one or more VF software (VFSW) drivers 64. A given application or other entity in host 28, which is assigned a certain PCIe function (PF or VF) accesses PCIe bus 32 by accessing a respective driver (PFSW or VFSW driver).

In an embodiment, switch SoC 18 further comprises an on-chip traffic monitor 76 (also referred to herein simply as “monitor” for brevity). Monitor 76 is disposed on the same semiconductor die as the network-device circuitry of SoC 18. On-chip traffic monitor 76 monitors traffic that traverses the network-device circuitry from one or more sources in the automotive network to one or more destinations in the automotive network (e.g., traffic between electronics subsystems 12 and central computer 16).

In the present example monitor 76 is coupled to routing and interconnection matrix 56. By monitoring the traffic flowing through routing and interconnection matrix 56, monitor 76 detects performance degradations using techniques that are described herein. Performance degradations may include network-level degradations, component-level degradations, or any other type of performance degradation.

In an embodiment, on-chip traffic monitor 76 comprises monitoring logic 80 and one or more hardware counters 84. Monitoring logic 80 carries out the various monitoring functions of monitor 76, including controlling HW counters 84.

In a typical mode of operation, monitoring logic 80 is configurable to monitor one or more traffic flows, selected from among the traffic traversing matrix 56. A selected traffic flow may comprise, for example, a flow associated with a selected Virtual Channel (VC), a flow associated with a selected PCIe bus function (PF or VF), a flow associated with a certain DMA engine 52, a flow associated with a selected Ethernet port 36, a flow associated with a selected memory region in the memory of host 28, a flow associated with a selected interrupt event, a Time-Sensitive Network (TSN) flow, or any other suitable type of flow.

Monitoring logic 80 assigns a respective hardware counter 84 to each traffic flow selected for monitoring. A given counter 84 measures the actual bandwidth (throughput) of the corresponding traffic flow, by counting the traffic of the flow (e.g., in bytes or other suitable units) over a defined measurement period. At the end of each measurement period, monitoring logic 80 reads the counter value (which is indicative of the throughput of the traffic flow during the measurement period), resets the counter and allows the counter to begin counting the traffic of the next measurement period. In this manner, monitor 76 obtains a sequence of throughput measurements of a selected traffic flow, in real time.

Such a sequence enables fast and accurate detection and localization of performance degradations. For example, a drop in throughput associated with a traffic flow associated with a given DMA engine 52 may be indicative of an imminent failure in that DMA engine. A complete, persistent loss of throughput in a certain traffic flow may be indicative of an actual failure.

In some embodiments, the measurement period of each hardware counter 84 is configurable, separately from other counters 84. This feature enables monitoring logic 80 to match the measurement period to the characteristics of the traffic flow being monitored. For example, traffic flows whose throughput fluctuates considerably may be assigned a longer measurement period for extra averaging. As another example, traffic flows characterized by very low throughput may be assigned a longer measurement period for collecting sufficient statistics.

In some embodiments, switch SoC 18 further comprises a Safety Monitor (SM) 68. SM 68 typically controls on-chip traffic monitor 76, e.g., configures monitor 76 with the appropriate traffic flows to be monitored, receives the monitoring results from monitor 76, and initiates suitable responsive actions.

In an example embodiment, SM 68 reads the monitoring results (e.g., counter values) from monitor 76, compares the monitoring results to a threshold or evaluates a certain criterion with respect the monitoring results, and notifies host 28 if the results are indicative of performance degradation, and possibly triggers a suitable responsive. Examples of responsive actions may comprise applying user-defined actions that are predefined for returning switch 18 to a safe state, adjusting hardware resources of switch 18, reassigning bandwidth in switch 18, etc.

Further aspects of SM 68 are described in U.S. patent application Ser. No. 17/949,231, entitled “Automotive network switch with hardware-implemented safety monitor,” filed Sep. 21, 2022, which is assigned to the assignee of the present patent application and whose disclosure is incorporated herein by reference.

In some embodiments, SoC 18 further comprises an Interrupt Control Unit (ICU) 72 that is configured to issue interrupts to host 28. The interrupts issued by ICU 72 typically comprise Message-Signaled Interrupts (MSI or MSI-X) sent via PCIe bus 32. In an embodiment, monitoring logic 80 and/or SM 68 use ICU 72 to issue an interrupt in response to detecting a performance degradation. Additionally or alternatively, monitoring logic 80 and/or SM 68 may notify host 28 of a detected performance degradation in any other suitable way. In an example embodiment, monitoring logic 80 and/or SM 68 notify host 28 of a performance degradation within tens of microseconds, less than typically 100 μsec (microseconds) from occurrence of the performance degradation.

The configurations of system 20, switch 18 and host 28, as shown in FIG. 1, are example configurations that are depicted solely for the sake of clarity. In alternative embodiments, any other suitable configurations can be used. For example, the description above presents a specific “division-of-labor”, i.e., task partitioning, among on-chip traffic monitor 76, SM 68 and host 28. In alternative embodiments, any other suitable task partitioning can be used.

As another example, the measurements performed by on-chip traffic monitor 76 are in no way limited to throughput measurements or to the use of counters. In alternative embodiments, on-chip traffic monitor 76 may detect performance degradations by analyzing various characteristics of the specified traffic flows, e.g., latencies, changes to intra-packet spacing, dropped packets, data corruption and traffic throughput exhibited in the monitored traffic flows.

In various embodiments, on-chip traffic monitor 76 may detect various kinds of performance degradations. Non-limiting examples of degradations include loss of PCIe credits, downgrading of PCIe link speed or bus width, hardware faults such as loss of read requests for DMA engine access, and many others.

The various elements of switch 18 may be implemented using dedicated hardware or firmware, such as using hard-wired or programmable logic, e.g., in an Application-Specific Integrated Circuit (ASIC) or Field-Programmable Gate Array (FPGA). Additionally, or alternatively, some functions of switch 18 may be implemented in software and/or using a combination of hardware and software elements. Elements that are not mandatory for understanding of the disclosed techniques have been omitted from the figure for the sake of clarity.

In some embodiments, some functions of switch 18, e.g., the functions of host 28, may be implemented in one or more programmable processors, e.g., one or more Central Processing Units (CPUs) or microcontrollers, which are programmed in software to carry out the functions described herein. The software may be downloaded to any of the processors in electronic form, over a network, for example, or it may, alternatively or additionally, be provided and/or stored on non-transitory tangible media, such as magnetic, optical, or electronic memory.

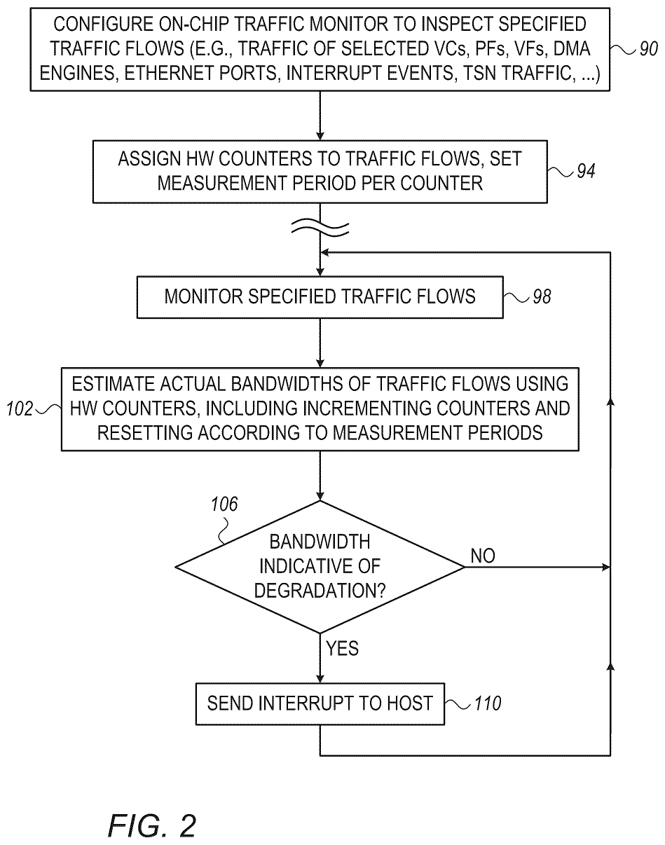

FIG. 2 is a flow chart that schematically illustrates a method for on-chip traffic monitoring, in accordance with an embodiment that is described herein. The method begins by configuring on-chip traffic monitor 76 to inspect one or more specified traffic flows, at a configuration operation 90. The configuration of monitor 76 may be performed, for example, by host 28. In an embodiment, host 28 also specifies a respective measurement period for each traffic flow.

At a counter assignment operation 94, monitoring logic 80 of monitor 76 assigns a respective hardware counter 84 to each of the traffic flows to be inspected. Monitoring logic also sets the appropriate measurement period for each counter 84.

At a monitoring operation 98, monitoring logic 80 monitors the traffic at an intermediate location in network 20, e.g., the traffic flowing through routing & interconnection matrix 56. The traffic typically comprises multiple packets, each packet originating from a certain source in the automotive network and destined to a certain destination in the automotive network. Monitoring logic 80 identifies the traffic of the specified traffic flows within the overall traffic passing through matrix 56.

At a measurement operation 102, monitoring logic 80 measures metrics such as the actual throughput (actual bandwidth) of each flow using the respective counter 84. Other suitable metrics may comprise, for example, latencies, changes to intra-packet spacing, dropped packets, data corruption and the like.

In an embodiment, to measure the throughput of a given traffic flow, monitoring logic 80 (i) increments the counter 84 assigned to the flow to count the traffic volume (e.g., number of bytes) of the flow, and (ii) reads the counter value and resets the counter at the end of each measurement period. As explained above, this process produces a sequence of real-time bandwidth readings per traffic flow, one reading per measurement period.

At a degradation checking stage 106, monitoring logic 80 checks whether the bandwidth readings (and/or other metrics) of any of the traffic flows are indicative of performance degradation. If not, the method loops back to stage 98 above. If performance degradation is detected, monitoring logic 80 notifies host 28 of the detected degradation, at a notification stage 110. For example, logic 80 may issue an interrupt to host 28 using ICU 72.

The method of FIG. 2 is an example method that is depicted solely for the sake of conceptual clarity. In alternative embodiments, any other suitable method can be used.

Although the embodiments described herein mainly address detection of performance degradation for the sake of safety and reliability, the methods and systems described herein can also be used in other applications. For example, the measurements performed by on-chip traffic monitor 76 can be used for identifying traffic bottlenecks, network optimization and traffic engineering. As another example, on-chip traffic monitor 76 may continuously update the maximum and minimum counter values of previous measurement periods, and calculate the average values for specific traffic flows. The host can use these values to implement bandwidth allocation.

It is noted that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A network device for use in an automotive network, the network device comprising:
a semiconductor die;
network-device circuitry, disposed on the die and configured to transfer traffic of the automotive network; and
an on-chip traffic monitor, disposed on the die and configured to monitor the traffic traversing the network-device circuitry from one or more sources in the automotive network to one or more destinations in the automotive network, and to detect a performance degradation in the network-device circuitry by analyzing the monitored traffic.

2. The network device according to claim 1, wherein the on-chip traffic monitor is configured to select a traffic flow from within the traffic, and to detect the performance degradation in the selected traffic flow.

3. The network device according to claim 1, wherein the network-device circuitry comprises:
multiple port circuits, disposed on the die and configured to transmit receive packets over the automotive network;
a switch fabric, disposed on the die and configured to forward the packets between the port circuits; and
interconnection circuitry, disposed on the die and configured to connect the switch fabric to a host via a peripheral bus,
wherein the on-chip traffic monitor is coupled to the interconnection circuitry.

4. The network device according to claim 3, wherein the on-chip traffic monitor is configured to identify, in the traffic, a traffic flow associated with a given bus function of the peripheral bus, and to detect the performance degradation by analyzing the identified traffic flow separately from one or more other traffic flows.

5. The network device according to claim 3, wherein the interconnection circuitry comprises a plurality of Direct Memory Access (DMA) engines, and wherein the on-chip traffic monitor is configured to identify, in the traffic, a traffic flow associated with a given DMA engine in the plurality, and to detect the performance degradation by analyzing the identified traffic flow separately from one or more other traffic flows.

6. The network device according to claim 1, wherein the on-chip traffic monitor is configured to:
identify, in the traffic, a traffic flow associated with one of (i) a virtual circuit, (ii) a port circuit among the port circuits, (iii) Time-Sensitive Network (TSN) traffic, (i) a defined memory region in a memory of the host, and (v) Message-Signaled Interrupt (MSI) traffic; and
detect the performance degradation by analyzing the identified traffic flow separately from one or more other traffic flows.

7. The network device according to claim 1, wherein the on-chip traffic monitor comprises one or more hardware counters, the on-chip traffic monitor configured to assign a hardware counter among the hardware counters for measuring a traffic throughput of a selected traffic flow within the traffic.

8. The network device according to claim 7, wherein the on-chip traffic monitor is configured to measure the traffic throughput by counting, using the hardware counter, a traffic volume of the selected traffic flow over a defined measurement period.

9. The network device according to claim 1, wherein the on-chip traffic monitor is configured to notify a host in response to detecting the performance degradation.

10. The network device according to claim 9, wherein the on-chip traffic monitor is configured to notify the host of the performance degradation within less than 100 microseconds from occurrence of the performance degradation.

11. The network device according to claim 1, wherein the on-chip traffic monitor is configured to detect the performance degradation by analyzing one or more of latencies, changes to intra-packet spacing, dropped packets, data corruption and traffic throughput exhibited in the monitored traffic.

12. A method of traffic monitoring in a network device of an automotive network, the method comprising:
using network-device circuitry disposed on a semiconductor die, transferring traffic of the automotive network; and
using an on-chip traffic monitor disposed on the semiconductor die, monitoring the traffic traversing the network-device circuitry from one or more sources in the automotive network to one or more destinations in the automotive network, and detecting a performance degradation in the network-device circuitry by analyzing the monitored traffic.

13. The method of traffic monitoring according to claim 12, wherein detecting the performance degradation comprises selecting a traffic flow from within the traffic, and detecting the performance degradation in the selected traffic flow.

14. The method of traffic monitoring according to claim 12, wherein:
transferring the traffic comprises (i) transmitting and receiving packets over the automotive network using multiple port circuits disposed on the die, (ii) forwarding the packets between the port circuits using a switch fabric disposed on the die, and (iii) using interconnection circuitry disposed on the die, connecting the switch fabric to a host via a peripheral bus; and
monitoring the traffic comprises monitoring the traffic traversing the interconnection circuitry.

15. The method of traffic monitoring according to claim 14, wherein detecting the performance degradation comprises identifying, in the traffic, a traffic flow associated with a given bus function of the peripheral bus, and detecting the performance degradation by analyzing the identified traffic flow separately from one or more other traffic flows.

16. The method of traffic monitoring according to claim 14, wherein the interconnection circuitry includes a plurality of Direct Memory Access (DMA) engines, and wherein detecting the performance degradation comprises identifying, in the traffic, a traffic flow associated with a given DMA engine in the plurality, and detecting the performance degradation by analyzing the identified traffic flow separately from one or more other traffic flows.

17. The method of traffic monitoring according to claim 12, wherein detecting the performance degradation comprises:
identifying, in the traffic, a traffic flow associated with one of (i) a virtual circuit, (ii) a port circuit among the port circuits, (iii) Time-Sensitive Network (TSN) traffic, (i) a defined memory region in a memory of the host, and (v) Message-Signaled Interrupt (MSI) traffic; and
detecting the performance degradation by analyzing the identified traffic flow separately from one or more other traffic flows.

18. The method of traffic monitoring according to claim 12, wherein monitoring the traffic comprises assigning a hardware counter, from among one or more hardware counters, for measuring a traffic throughput of a selected traffic flow within the traffic.

19. The method of traffic monitoring according to claim 18, wherein monitoring the traffic comprises measuring the traffic throughput by counting, using the hardware counter, a traffic volume of the selected traffic flow over a defined measurement period.

20. The method of traffic monitoring according to claim 12, wherein detecting the performance degradation comprises analyzing one or more of latencies, changes to intra-packet spacing, dropped packets, data corruption and traffic throughput exhibited in the monitored traffic.
